(19) United States
(12) Patent Application Publication
(10) Pub. No.: US 2018/0242556 A1
(43) Pub. Date: Aug. 30, 2018

(54) Cardboard Cat Ball Track Wobble Toy

(71) Applicant: James Donald Koskey, JR., Manitou Springs, CO (US)

(72) Inventor: James Donald Koskey, JR., Manitou Springs, CO (US)

(21) Appl. No.: 15/421,922

(22) Filed: Feb. 1, 2017

(51) Int. Cl. A01K 15/02

(52) U.S. Cl. CPC A01K 15/024; A01K 15/025

(57) ABSTRACT

A cat scratch toy has a housing with a truncated ellipsoid shape. The housing has a flat surface. There is a continuous track in a face of the flat surface. A ball is in the continuous track. In one case, the housing is made of cardboard. The cardboard is laminated sheets cut into different shapes. In one case, there is a bowl section and a cylindrical section affixed to an interior of the bowl section. The track is formed between the edge of the cylindrical section and a wall of the bowl section. The wobbly shape of the cat scratch toy along with the ball in the track keeps the cat endlessly entertained, while satisfying the cat's need to scratch.

### RELATED APPLICATIONS

Not Applicable

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Cats have been gaining in popularity as pets. Cats need exercise and they need a place to scratch. There have been numerous toys designed to entertain cats including hanging balls, catnip stuffed animals, and even dancing laser lights the cat is supposed to chase. There have also been many cat scratch devices. Most of these are made of carpet, fabric, rope, or cardboard. Some of these are specifically made of Sisal, which cats are supposed to like better than other fibers. Most cats become bored fairly quickly with their toys and are prone to scratch not only their scratching devices, but the furniture also.

Thus there exists a need for a device that is both a cat toy and a cat scratching device.

### BRIEF SUMMARY OF INVENTION

A cat scratch toy that overcomes these and other problems has a housing with a truncated ellipsoid shape. The housing has a flat surface. There is a continuous track in a face of the flat surface. A ball is in the continuous track. In one embodiment, the housing is made of cardboard. The cardboard is laminated sheets cut into different shapes. In one embodiment, there is a bowl section and a cylindrical section affixed to an interior of the bowl section. The track is formed between the edge of the cylindrical section and a wall of the bowl section. The wobbly shape of the cat scratch toy along with the ball in the track keeps the cat endlessly entertained, while satisfying the cat's need to scratch.

### BRIEF DESCRIPTION OF THE SEVERAL VIEWS OF THE DRAWINGS

FIG. 1 is a top right perspective view of a cat scratch toy in accordance with one embodiment of the invention;

FIG. 2 is a bottom view of a cat scratch toy in accordance with one embodiment of the invention;

FIG. 3 is a side view of a cat scratch toy in accordance with one embodiment of the invention;

FIG. 4 is a top right perspective view of a bowl section of a cat scratch toy in accordance with one embodiment of the invention;

FIG. 5 is a top view of a cylindrical section of a cat scratch toy in accordance with one embodiment of the invention;

FIG. 6 is a side view of a ball for a cat scratch toy in accordance with one embodiment of the invention;

FIG. 7 is a top perspective view of a plurality of bowl base layers of a cat scratch toy in accordance with one embodiment of the invention;

FIG. 8 is a top view of a cylinder holder layer of a cat scratch toy in accordance with one embodiment of the invention;

FIG. 9 is a top view of a track forming layer of a cat scratch toy in accordance with one embodiment of the invention; and

FIG. 10 is a top view of a top layer of a cat scratch toy in accordance with one embodiment of the invention.

### DETAILED DESCRIPTION OF THE INVENTION

The invention is directed to a cat scratch toy that has a housing with a truncated ellipsoid shape. The housing has a flat surface. There is a continuous track in a face of the flat surface. A ball is in the continuous track. In one embodiment, the housing is made of cardboard. The cardboard is laminated sheets cut into different shapes. In one embodiment, there is a bowl section and a cylindrical section affixed to an interior of the bowl section. The track is formed between the edge of the cylindrical section and a wall of the bowl section. The wobbly shape of the cat scratch toy along with the ball in the track keeps the cat endlessly entertained, while satisfying the cat's need to scratch.

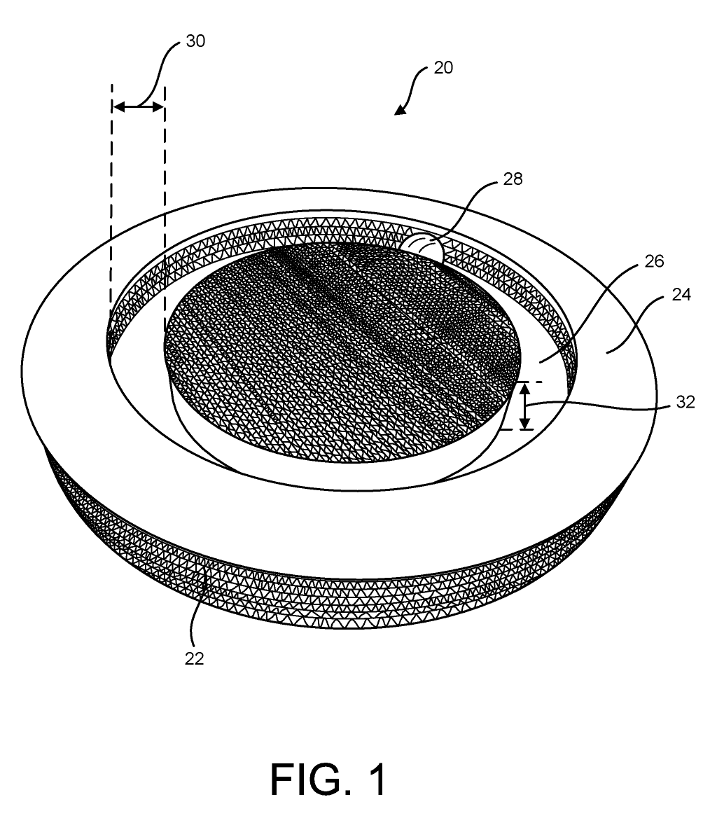

FIG. 1 is a top right perspective view of a cat scratch toy 20 in accordance with one embodiment of the invention. The cat scratch toy 20 has a housing 22 that has a truncated ellipsoid shape with a flat face 24. A continuous track 26 is formed in the flat face 24 of the housing 22. A ball 28 is in the circular track 26. In one embodiment, the ball 28 is replaced with another toy such as spiked ball or star shaped toy or similar. The top width 30 of the track 26 is less than the diameter of the ball 28, which keeps the ball 28 trapped within the track 26. The depth 32 of the track 26 is generally equal to or greater than the diameter of the ball 28, however the only requirement is that the ball 28 be able to move freely along the track 26. Note that the truncated ellipsoidal shape results in the toy 20 tipping around freely as the cat bats at the ball 28 or scratches the housing 22. Note that the housing 22 is made of laminated layers of cardboard in one embodiment, which is one of the most common cat scratch materials.

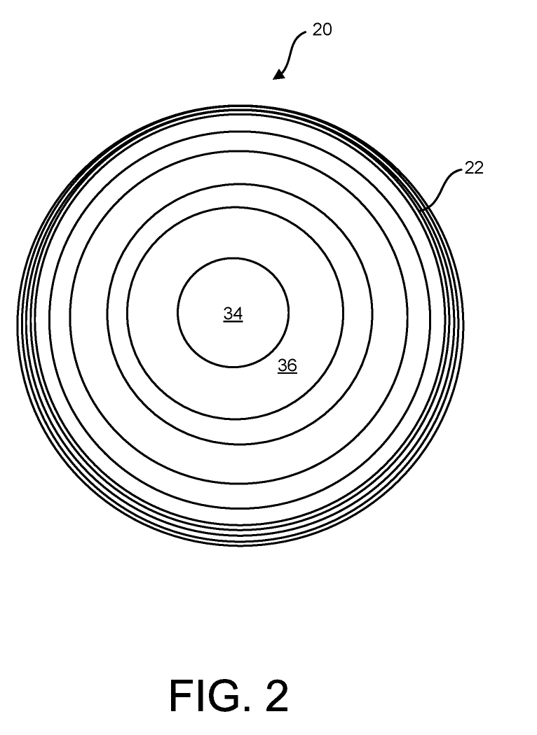

FIG. 2 is a bottom view of a cat scratch toy 20 in accordance with one embodiment of the invention. This view shows how the layers of cardboard are cut to form the housing 22. The most base layer 34 is a circular shaped sheet of cardboard. The next layer up 36 is a larger circular shaped sheet of cardboard.

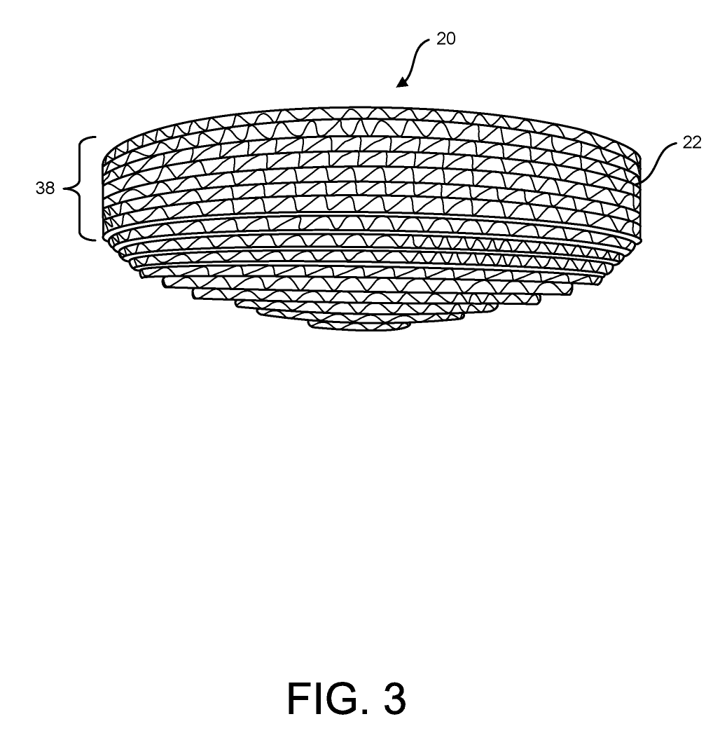

FIG. 3 is a side view of a cat scratch toy 20 in accordance with one embodiment of the invention. This view shows the layers of cardboard that form the housing 22. Note that in this embodiment, the upper or track layers 38 all have the same diameter. In other embodiments, this is not the case.

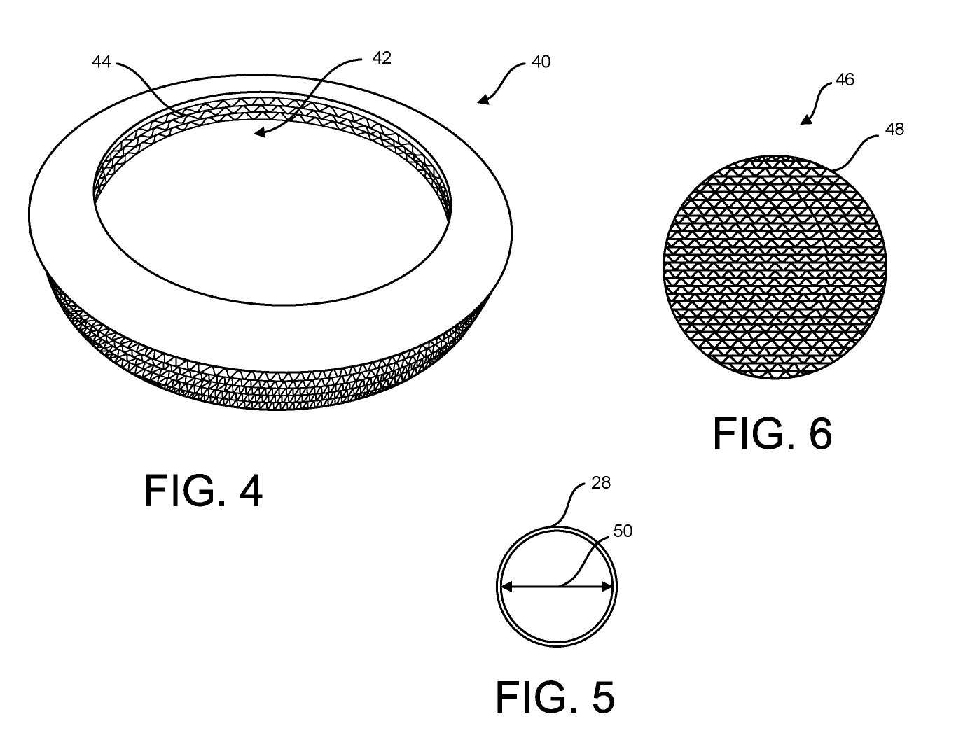

FIG. 4 is a top right perspective view of a bowl section 40 of a cat scratch toy in accordance with one embodiment of the invention. The bowl section 40 has an interior space 42 that forms a wall 44.

FIG. 5 is a top view of a cylindrical section 46 of a cat scratch toy in accordance with one embodiment of the invention. The cylindrical section 46 is placed in the interior 42 of the bowl section 40. In one embodiment, the cylindrical section 46 is adhered to the bowl section 40. In another embodiment, the cylindrical section 46 friction fits into a part of the interior 42 of the bowl section 40. In another embodiment, the cylindrical section 46 is covered with paper 48 so that the edges of the cardboard layers are not exposed on the side.

FIG. 6 is a side view of a ball 28 for a cat scratch toy in accordance with one embodiment of the invention. This view shows the diameter 50 of the ball 28.

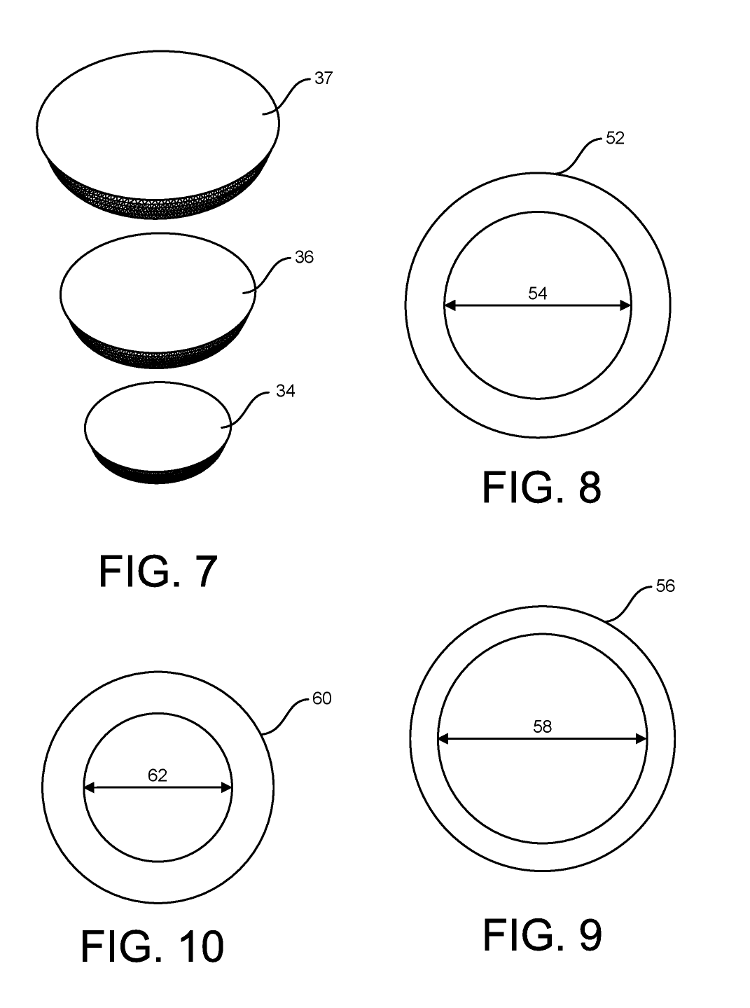

FIG. 7 is a top perspective view of a plurality of bowl base layers 34, 36, 38 of a cat scratch toy in accordance with one embodiment of the invention. This view shows that the base of the cat scratch toy 20 is made of solid circular layers of increasing diameter.

FIG. 8 is a top perspective view of a cylinder holder layer 52 of a cat scratch toy in accordance with one embodiment of the invention. This view shows that the cylindrical holder layer 52 is made up of one or more layers where the holder diameter 54 is essentially the same as the diameter of the cylindrical section 46.

FIG. 9 is a top perspective view of a track forming layer 56 of a cat scratch toy in accordance with one embodiment of the invention. The track 26 is made up a number of track forming layers 56. The track diameter 58 is set so that the difference with the cylindrical section 46 diameter is equal to or greater than the ball 28 diameter 50.

FIG. 10 is a top perspective view of a top layer of a cat scratch toy 60 in accordance with one embodiment of the invention. The top layer diameter 62 is set so that the difference with the cylindrical section 46 diameter is less than the ball 28 diameter 50.

Thus there has been described a cat scratch toy with a wobbly shape and a ball in a track that keeps cats endlessly entertained, while satisfying a cat's need to scratch.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A cat scratch toy, comprising:
a housing having a truncated ellipsoid shape, having a flat surface;
a continuous track in a face of the flat surface;
a ball in the continuous track.

2. The cat scratch toy of claim 1, wherein the housing is made of a cat-scratch material.

3. The cat scratch toy of claim 2, wherein the housing is a laminate.

4. The cat scratch toy of claim 3, wherein the housing is made of sheets of cardboard.

5. The cat scratch toy of claim 1, wherein the continuous track is a circle.

6. The cat scratch toy of claim 5, wherein a depth of the continuous track is greater than a diameter of the ball.

7. The cat scratch toy of claim 6, wherein a top width of the continuous track is less than the diameter of the ball.

8. A cat scratch toy, comprising:
a housing made of a laminate of cardboard sheets, wherein the housing has a flat face;
a track in the flat face; and
a toy in the track.

9. The cat scratch toy of claim 8, wherein the toy is a ball.

10. The cat scratch toy of claim 9, wherein a top opening of the track is less than a diameter of the ball.

11. The cat scratch toy of claim 10, wherein a depth of the track is at least equal to the diameter of the ball.

12. The cat scratch toy of claim 11, wherein the housing has a roughly ellipsoidal shape.

13. The cat scratch toy of claim 12, wherein the track is a continuous loop.

14. The cat scratch toy of claim 8, wherein the housing has a bowl portion and a cylindrical portion.

15. A cat scratch toy, comprising:
a bowl section having an interior section;
a cylindrical section affixed to the interior section of the bowl and forming a track between a wall of the bowl and the cylindrical section; and
a toy that moves freely along the track.

16. The cat scratch toy of claim 15, wherein the bowl is made of a plurality of layered cardboard sheets.

17. The cat scratch toy of claim 16, wherein the cylindrical section is made of a second plurality of layered cardboard sheets.

18. The cat scratch toy of claim 17, wherein the plurality of layered cardboard sheets are perpendicular to the second plurality of layered cardboard sheets.

19. The cat scratch toy of claim 15, wherein the toy is a ball and it is trapped in the track.
